(19) United States
(12) Patent Application Publication
(10) Pub. No.: US 2024/0215000 A1
(43) Pub. Date: Jun. 27, 2024

(54) COMMUNICATION APPARATUS

(71) Applicant: JVCKENWOOD Corporation, Yokohama-shi (JP)

(72) Inventor: Kazuomi TACHIGI, Yokohama-shi (JP)

(21) Appl. No.: 18/597,836

(22) Filed: Mar. 6, 2024

Related U.S. Application Data
(63) Continuation of application No. PCT/JP2022/033198, filed on Sep. 2, 2022.

(30) Foreign Application Priority Data
Sep. 24, 2021 (JP) 2021-155080

(51) Int. Cl. H04W 72/0446; H04L 5/14; H04W 72/563

(52) U.S. Cl. CPC H04W 72/0446; H04L 5/14; H04W 72/563

(57) ABSTRACT

In a communication apparatus, a receiving unit receives signals alternately in a first slot and a second slot according to a time division multiplexing access scheme. A voice signal decoding unit decodes a voice signal of one of a first reception signal and a second reception signal. A recording device records the first or second reception signal. A baseband signal processing unit determines a priority from information contained in the first and second reception signals, and outputs information about the priority. When the first reception signal is received in the first slot and then the second reception signal having a priority higher than that of the first reception signal is received, a control circuit switches a slot for outputting a voice to a second slot, and makes the recording device start recording the first reception signal.

### CROSS REFERENCE TO RELATED APPLICATION

The present application is based upon and claims the benefit of priority from Japanese Patent Application No. 2021-155080, filed on Sep. 24, 2021, the disclosure of which are incorporated herein in its entirety by reference.

### BACKGROUND

The present invention relates to a communication apparatus.

A radio communication technology called DMR (Digital Mobile Radio) enables two independent communication accesses (e.g., first and second slots) to be simultaneously performed by using a TDMA (Time Division Multiple Access) scheme. By using this technology, when a communication apparatus which is performing a call by using one of the slots receives a signal in the other slot, the communication apparatus can switch the slot through which it is performing the call to the other slot.

For example, a radio communication system that selects one of a plurality of repeaters connected by communication lines when a radio terminal communicates with another radio terminal is disclosed (Japanese Unexamined Patent Application Publication No. 2010-109506).

This radio terminal performs an analysis to determine, when call information is contained in communication information, whether or not the radio terminal itself is included as the other end of the call in the call information. Further, when the radio terminal itself is included as the other end of the call, the radio terminal determines whether or not the priority of the call information is higher than that of the call the radio terminal is currently performing, and when the priority of the call information is higher than the current call, the radio terminal changes the communication channel to the channel of another repeater contained in the call information.

### SUMMARY

However, if a communication apparatus in conformity with the DMR scheme receives a signal having a high priority in a second slot while it is outputting a voice (or a sound) represented by a signal received in a first slot, the communication apparatus switches the slot for outputting the voice from the first slot to the second slot. Therefore, the user of this communication apparatus fails to hear the voice of the first slot halfway through the call. Further, a person or the like at the other end of the call, who is speaking to a person or the like using the communication apparatus through the first slot, cannot recognize that the slot has been switched halfway through the call.

An embodiment of the present disclosure has been made in order to solve such a problem, and an object thereof is to provide a communication apparatus and the like capable of preventing a problem or the like which would otherwise be caused by the switching of slots.

A communication apparatus according to an embodiment includes a receiving circuit, a voice signal decoding circuit, a recording device, and a control circuit. The receiving circuit receives a signal in a first slot or a second slot according to a time division multiplexing access scheme. The voice signal decoding circuit handles one of a received first reception signal and a received second reception signal as a signal for outputting a voice, and decodes the voice signal. The recording device is configured so as to be able to record at least a voice signal contained in at least one of the first and second reception signals. A baseband signal processing circuit determines a priority based on information contained in the first and second reception signals, and outputs information about the determined priority. When the first reception signal is received in the first slot and then the second reception signal having a priority higher than that of the first reception signal is received, the control circuit switches a slot for outputting a voice from the first slot for the first reception signal to the second slot for the second reception signal, and makes the recording device start recording a signal corresponding to at least a voice signal contained in the first reception signal.

According to the embodiment, it is possible to provide a communication apparatus and the like capable of preventing a problem or the like which would otherwise be caused by the switching of slots.

### BRIEF DESCRIPTION OF THE DRAWINGS

FIG. 1 is a block diagram of a communication apparatus according to a first embodiment;

FIG. 2 is a functional block diagram of the communication apparatus according to the first embodiment;

FIG. 3 is a schematic diagram of a configuration of a communication system including a communication apparatus 10 according to the first embodiment;

FIG. 4 is a diagram for explaining frame structures of transmission/reception signals according to the first embodiment;

FIG. 5 shows an example of a list chunk format in the communication apparatus 10;

FIG. 6 is a diagram for explaining data contained in a list chunk;

FIG. 7 shows an example of a list chunk of a system according to the first embodiment;

FIG. 8 is a method for reading a list chunk performed by the communication apparatus 10;

FIG. 9 is a flowchart showing a process for recording a reception signal;

FIG. 10 is a flowchart showing a talk-back process when a recorded voice is being played back;

FIG. 11 is a first diagram for explaining functions of a communication apparatus according to a second embodiment;

FIG. 12 is a first sequence diagram showing processes performed by the communication apparatus according to the second embodiment;

FIG. 13 is a second diagram for explaining functions of the communication apparatus according to the second embodiment;

FIG. 14 is a second sequence diagram showing processes performed by the communication apparatus according to the second embodiment;

FIG. 15 is a sequence diagram showing processes performed by a communication apparatus according to a third embodiment; and

FIG. 16 is a sequence diagram showing processes performed by a communication apparatus according to a fourth embodiment.

### DETAILED DESCRIPTION

The present invention will be described hereinafter through embodiments of the invention, but the invention according to the claims is not limited to the below-shown embodiments. Further, all the components/structures described in the embodiments are not necessarily indispensable as means for solving the problem. For clarifying the explanation, the following description and the drawings are partially omitted and simplified as appropriate. Note that the same reference numerals (or symbols) are assigned to the same elements throughout the drawings, and redundant descriptions thereof are omitted as appropriate.

### First Embodiment

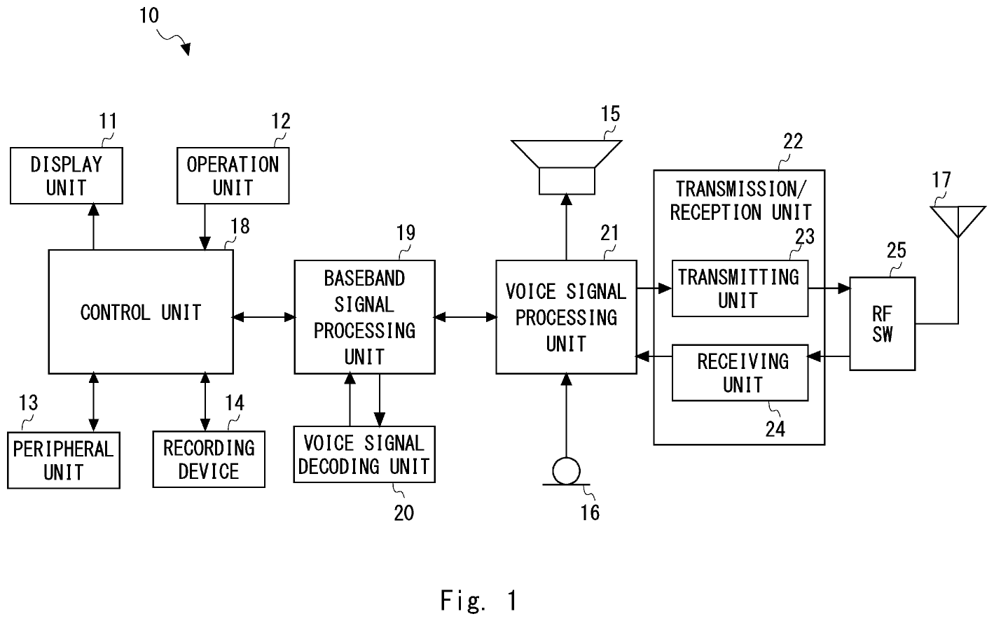

Embodiments according to the present invention will be described hereinafter with reference to the drawings. A communication apparatus according to an embodiment will be described with reference to FIG. 1. FIG. 1 is a block diagram of a communication apparatus 10 according to an embodiment. The communication apparatus 10 is an embodiment of a communication apparatus. The communication apparatus 10 is a radio apparatus that transmits and receives frequency-modulated signals, and conforms to DMR (Digital Mobile Radio) standards. The DMR standards are communication standards specified by ETSI (European Telecommunications Standards Institute).

The communication apparatus 10 includes, as its main components, a recording device 14, a control unit 18, a baseband signal processing unit 19, a voice signal decoding unit 20, a voice signal processing unit 21, and a transmission/reception unit 22 (a transmitting unit 23 and a receiving unit 24). Further, in addition to the above-described components, the communication apparatus 10 also includes a display unit 11, an operation unit 12, a peripheral unit 13, a speaker 15, a microphone 16, an antenna 17, and an RF switch unit 25.

The recording device 14 includes, for example, a nonvolatile memory such as a flash memory. The recording device 14 is configured so as to be able to record at least a voice signal contained in at least one of a first reception signal and a second reception signal. The recording device 14 may be disposed inside the communication apparatus 10 or may be detachably attached to the communication apparatus 10.

The control unit 18 is also referred to as a control circuit. Some or all of the components of the control unit 18 may be implemented by general purpose or dedicated circuitry, a processor, or a combination thereof. They may be configured by a single chip or by a plurality of chips connected to each other through a bus. More specifically, the control unit 18 may include, for example, a CPU (Central Processing Unit) or an MCU (Micro Controller Unit).

The control unit 18 receives various signals from each of the components of the communication apparatus 10 and controls each of the components according to the received signals. For example, the control unit 18 receives a predetermined operation from the operation unit 12 and performs a function of the communication apparatus 10 according to the received operation. Note that the control unit 18 can exchange signals with the baseband signal processing unit 19 and the voice signal processing unit 21 in order to implement functions according to this embodiment. Further, for example, when the communication apparatus 10 receives a reception signal, the control unit 18 receives accessory information contained in this reception signal from the baseband signal processing unit 19 and processes the received accessory information. That is, for example, when a message to be displayed is contained in such accessory information of a reception signal, the control unit 18 displays this message on the display unit 11.

Further, the control unit 18 performs processing for each of a first slot and a second slot in conformity with DMR. More specifically, for example, when the communication apparatus 10 receives a first reception signal in the first slot and receives no signal in the second slot, the control unit 18 reads accessory information contained in the first reception signal and supplies the read accessory information to the control unit 18. Further, the control unit 18 supplies a voice signal contained in the first reception signal to the voice signal decoding unit 20 in order to output it from the speaker 15.

Further, when the communication apparatus 10 receives a first reception signal in the first slot and then receives a second reception signal having a priority higher than that of the first reception signal in the second slot, the control unit 18 switches the slot for outputting a voice from the first slot for the first reception signal to the second slot for the second reception signal. In this case, the control unit 18 continues detecting the first reception signal and makes the recording device start recording a signal corresponding to at least a voice signal contained in the first reception signal.

The baseband signal processing unit 19 is a circuit block including, for example, a DSP (Digital Signal Processor), and may also be referred to as a baseband signal processing circuit. The baseband signal processing unit 19 may exchange signals with the control unit 18 and the voice signal processing unit 21 in order to implement functions according to this embodiment. The baseband signal processing unit 19 receives the reception signal received by the communication apparatus 10 through the transmitting unit 23 and reads information contained in the received reception signal.

More specifically, for example, the baseband signal processing unit 19 reads each of the first reception signal in the first slot and the second reception signal in the second slot in conformity with DMR, and determines priorities thereof from information contained in the first and second reception signals. The baseband signal processing unit 19 supplies information about the determined priorities to the control unit 18. Examples of information contained in a reception signal include information indicating that the type of the signal relates to the form of the call having a certain type, such as an individual call and a group call, and information indicating a special call (e.g., an emergency call). For these types of signals, it is necessary to set a priority order in advance in order to operate a radio communication system using the above-described communication apparatus. Further, information indicating a priority may be contained in the information contained in the reception signal. The technology according to this embodiment is a technology in which attention is focused on the priority determined from the information contained in the reception signal. Therefore, in the following description, an expression “the priority contained in the reception signal may be read” or the like is used.

Further, for example, the baseband signal processing unit 19 supplies a predetermined reception signal to the voice signal decoding unit 20 in order to output a voice from the speaker 15. In this case, the baseband signal processing unit 19 receives a voice signal decoded by the voice signal decoding unit 20. Further, the baseband signal processing unit 19 supplies the received voice signal to the speaker 15 through the voice signal processing unit 21. In this way, the speaker 15 outputs the voice signal contained in the reception signal.

The voice signal decoding unit 20 is also referred to as a voice signal decoding circuit or a vocoder. The voice signal decoding unit 20 handles one of the received first reception signal and the received second reception signal as a signal for outputting a voice, and decodes the voice signal. The voice signal decoding unit 20 receives the reception signal from the baseband signal processing unit 19 and decodes the received reception signal. Then, the voice signal decoding unit 20 supplies the decoded voice signal to the baseband signal processing unit 19.

The voice signal processing unit 21 is also referred to as a voice signal processing circuit. The voice signal processing unit 21 can exchange signals with the baseband signal processing unit 19 and the control unit 18 in order to implement functions according to this embodiment. The voice signal processing unit 21 performs an A/D (Analog to Digital) conversion of a voice signal received from the microphone 16, generates a modulated wave by performing various processes such as band limitation on the A/D-converted voice signal, and supplies the generated modulated wave to the transmission/reception unit 22. Further, the voice signal processing unit 21 performs a D/A (Digital to Analog) conversion of a voice signal received from the voice signal decoding unit 20, and supplies a voice signal that is generated by demodulating and decoding the D/A-converted voice signal to the speaker 15.

The transmission/reception unit 22 is a circuit block including the transmitting unit 23 and the receiving unit 24. The transmission/reception unit 22 transmits data to other radio apparatuses according to a half-duplex communication scheme. The transmission/reception unit 22 receives data transmitted from other radio apparatuses by the half-duplex communication scheme. The other radio apparatuses may be those that operate as relay stations.

When the transmission/reception unit 22 receives a signal through the antenna 17 and the RF switch unit 25, it supplies the received signal (reception signal) to the voice signal processing unit 21. Further, when the transmission/reception unit 22 receives a signal to be transmitted from the voice signal processing unit 21 to other radio apparatuses (i.e., a transmission signal), it outputs the received transmission signal to the antenna 17 through the RF switch unit 25. The RF switch unit 25 is also referred to as a high-frequency switch. The RF switch unit 25 switches the path of reception signals and the path of transmission signals as appropriate.

The receiving unit 24 is also referred to as a receiving circuit. The receiving unit 24 alternately receives a first reception signal received in the first slot and a second reception signal received in the second slot according to a time division multiplexing access scheme.

The transmitting unit 23 is also referred to as a transmitting circuit. The transmitting unit 23 transmits a transmission signal corresponding to the first or second slot according to the time division multiplexing access scheme and by half-duplex communication.

The display unit 11 is a display device including a liquid-crystal panel and displays various types of information. The display unit 11 receives, from the control unit 18, an instruction in regard to contents displayed on the display unit 11. For example, the display unit 11 may display information about the station from which the communication apparatus 10 is receiving a signal or the like (hereinafter also referred to as the other station). For example, there is a case where the communication apparatus 10 receives signals in both the first and second slots, outputs a voice in one of the slots from the speaker, and records a voice in the other slot in the recording device without outputting it from the speaker. In this case, the display unit 11 may display, for example, “Back slot busy” as a display indicating that the communication apparatus 10 is receiving a signal in the slot other than the slot for the signal the voice of which is being output from the speaker. Note that “Back slot busy” means that, under the assumption that the slot for the signal the voice of which is being output is defined as the front and the slot for the signal the voice of which is not being output is defined as the back, a signal is also being received in the back slot.

The operation unit 12 is a user interface, such as operation keys, that is provided to enable the communication apparatus 10 to implement its functions. The operation unit 12 includes, for example, a PTT switch.

The PTT switch is an operation unit for implementing half-duplex communication by push-to-talk. For example, when a user speaks and transmits a voice signal, the user presses the PTT switch. The control unit 18 brings the communication apparatus 10 into a reception standby state when the PTT switch is not being pressed, and brings the communication apparatus 10 into a transmission state when the PTT switch is being pressed.

The peripheral unit 13 may include, for example, an interface with external connection devices such as an earphone and a USB (Universal Serial Bus) terminal, and a user interface such as LEDs (Light-Emitting Diodes) and a buzzer.

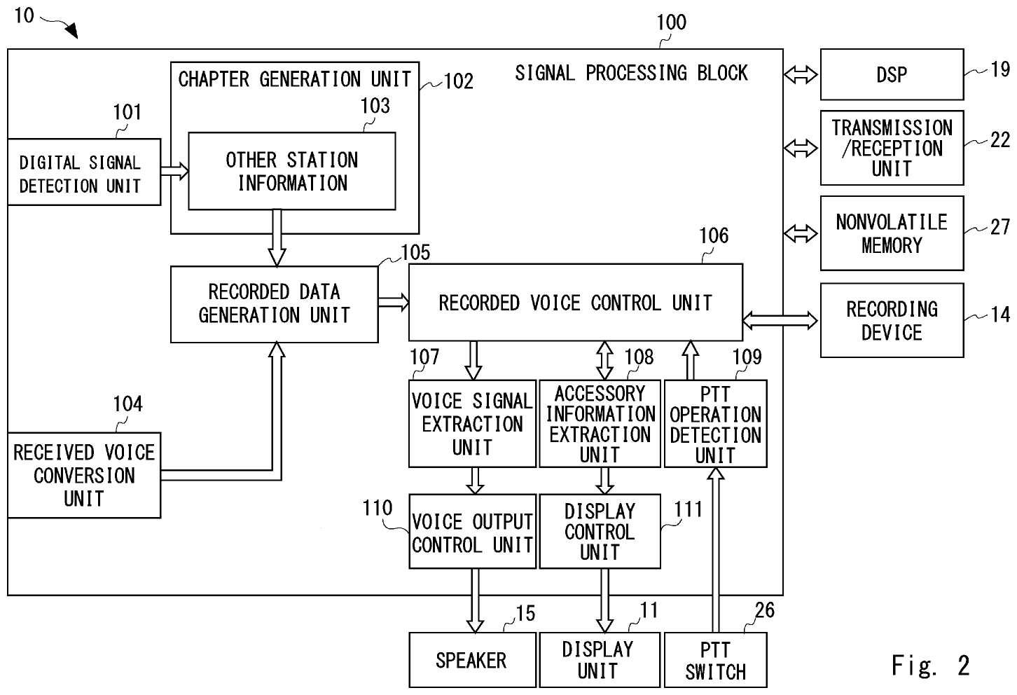

Next, a functional configuration of the communication apparatus 10 will be described with reference to FIG. 2. FIG. 2 is a functional block diagram of the communication apparatus 10 according to the first embodiment. FIG. 2 shows, among the functions of the communication apparatus 10, a function of the communication apparatus 10 for recording a voice signal contained a reception signal. A signal processing block 100 shown in FIG. 1 shows functions implemented by components of the communication apparatus 10, and they do not necessarily have to physically correspond to the components shown in FIG. 1. The signal processing block 100 may be implemented by having a plurality of components shown in FIG. 1 interact with each other. Alternatively, the signal processing block 100 may represent some of the functions of the control unit 18 and the like.

In the communication apparatus 10 shown in FIG. 2, the signal processing block 100 includes a digital signal detection unit 101, a chapter generation unit 102, a reception voice conversion unit 104, a recorded data generation unit 105, a recorded voice control unit 106, a voice signal extraction unit 107, an accessory information extraction unit 108, a PTT operation detection unit 109, a voice output control unit 110, and a display control unit 111. Further, the signal processing block 100 connects the display unit 11, the recording device 14, the speaker 15, the baseband signal processing unit 19, the transmission/reception unit 22, a PTT switch 26, and a nonvolatile memory 27 to each other so that they can communicate with each other.

The digital signal detection unit 101 of the signal processing block 100 reads a reception signal and supplies information about the other station from which the communication apparatus 10 has received the reception signal to the chapter generation unit 102. The information about the other station may include, for example, a frequency of the reception signal, an ID (identification, identifier) of the other station, a priority of the reception signal, whether the slot in which the signal has been received is a first slot or a second slot, and a receiving start time. Upon receiving the above-described information, the chapter generation unit 102 supplies the received information to the recorded data generation unit 105 as appropriate. Further, the reception voice conversion unit 104 performs an A/D conversion on the received voice signal and supplies the A/D-converted data to the recorded data generation unit 105.

Next, the recorded data generation unit 105 generates recorded data by combining the voice signal and the information about the other station. The recorded data generation unit 105 supplies the generated recorded data to the recorded voice control unit 106. Further, the recorded voice control unit 106 performs a process for writing the recorded data in the recording device 14.

When the recorded voice is played back, the recorded voice control unit 106 reads the data from the recording device 14 and supplies the read data to the voice signal extraction unit 107 and the accessory information extraction unit 108. The voice signal extraction unit 107 extracts a voice signal contained in the recorded data and supplies the extracted voice signal to the voice output control unit 110. The voice output control unit 110 outputs the received voice signal from the speaker 15.

Meanwhile, the accessory information extraction unit 108 extracts accessory information, such as information about the other station, contained in the recorded data, and supplies predetermined information to be displayed on the display unit 11 contained in the extracted accessory information to the display control unit 111. The display control unit 111 receives predetermined accessory information from the accessory information extraction unit 108 and displays the received predetermined accessory information on the display unit 11.

Next, a process that is performed when the PTT switch is depressed while a recorded voice signal is being played back will be described. When the PTT switch 26 is depressed while a voice signal related to the recorded data is being output from the speaker 15 (i.e., while the recorded voice is being played back), the communication apparatus 10 can transmit a signal to the other station related to the voice that is being played back (i.e., can perform talk-back). That is, for example, when the user of the communication apparatus 10 depresses the PTT switch 26, the signal processing block 100 acquires the ID of the other station from the accessory information of the voice signal that is being played back, and transmits a signal by using the acquired ID. In this way, even after the reception of the signal from the other station is finished, the communication apparatus 10 can transmit a signal to the other station of which the voice signal is being played back.

Note that the nonvolatile memory 27 is, for example, a memory or the like included in the control unit 18, and in which, for example, a computer program (hereinafter also referred to simply as a program) for performing a communication method according to this embodiment is stored. The control unit 18 loads the program from the recording device 14 onto a random-access memory and executes the loaded program.

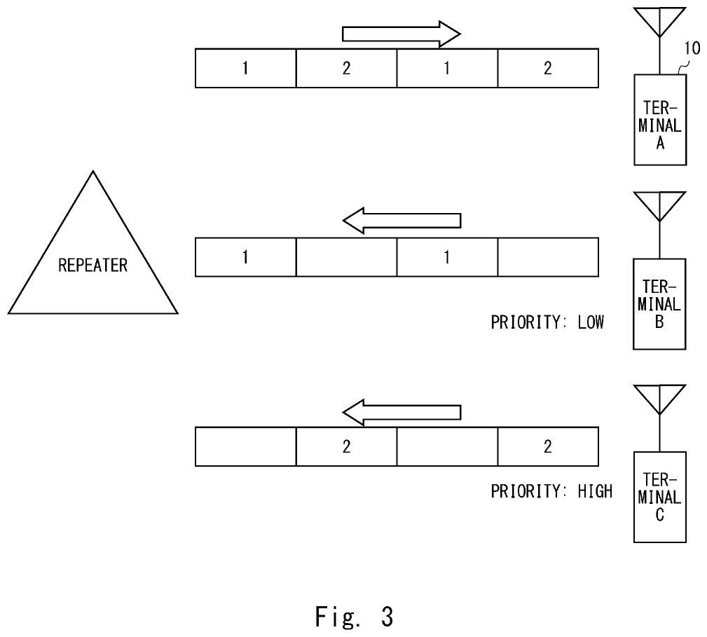

Next, an example of a communication system including the communication apparatus 10 will be described with reference to FIG. 3. FIG. 3 is a schematic diagram of a configuration of a communication system including the communication apparatus 10 according to the first embodiment. FIG. 3 shows a terminal A, a terminal B, and a terminal C, each of which is a communication apparatus 10, and also includes a repeater. The terminals A, B and C transmit and receive signals in conformity with DMR standards. The repeater relays signals of the terminals A, B and C. In FIG. 3, band-like rectangles and arrows shown between the terminals A, B and C and the repeater conceptionally represent signals transmitted and received by the respective terminals.

In the above-described configuration, the terminal B starts transmitting a signal by using, of the first and second slots, the first slot. In this state, the terminal A receives the signal of the first slot transmitted by the terminal B through the repeater.

Meanwhile, the terminal C starts transmitting a signal by using, of the first and second slots, the second slot. In this state, the terminal A receives the signal of the second slot transmitted by the terminal C through the repeater.

As described above, the terminal A can receive both the signal of the first slot transmitted from the terminal B and the signal of the second slot transmitted from the terminal C. Note that the terminal B can set a priority when it transmits a signal. Similarly, the terminal C can set a priority when it transmits a signal. Note that in the example shown in FIG. 3, it is assumed that the priority of the signal transmitted by the terminal C is higher than that of the signal transmitted by the terminal B. In this case, the terminal A outputs the voice signal of the terminal C from the speaker irrespective of which of the signals has arrived earlier than the other signal. Note that the priority can be directly set. However, in the case where the priority is set in advance according to the form of the call on the receiving side as described above, the setting of a priority includes selecting the form of the call of which the priority is high.

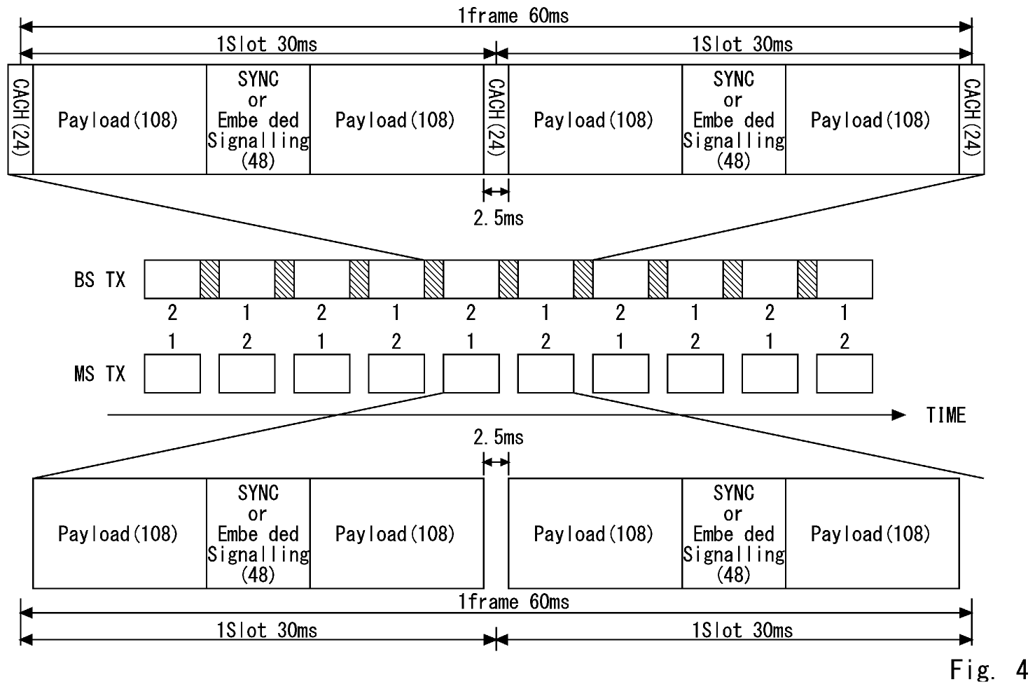

Next, general frame structures of DMR transmission/reception signals will be described with reference to FIG. 4. FIG. 4 is a diagram for explaining frame structures of transmission/reception signals according to the first embodiment. In FIG. 4, a transmission signal (BS TX) of a base station is shown on the upper side and a transmission signal (MS TX) of a mobile station is shown on the lower side.

The transmission signal of the base station shown on the upper side of FIG. 4 is configured so that the first and second slots alternately arranged. Regarding the transmission signal of the base station, a combination of the first and second slots is defined as one frame. Further, the transmission period of each of the first and second slots is 30 milliseconds, and the transmission period of one frame, in which the first and second slots are combined, is set to 60 milliseconds. Further, each slot includes a 108-bit payload and a 48-bit SYNC or Embedded Signaling. The payload includes a voice signal. Note that in the transmission signal of the base station, a period during which a 24-bit CACH (Common Announcement Channel) signal indicating the use state and the like of a slot is transmitted is set in a period of 2.5 milliseconds between adjacent first and second slots, and between adjacent second and first slots.

The transmission signal of the mobile station shown on the lower side of FIG. 4 is also configured so that the first and second slots alternately arranged. Regarding the transmission signal of the mobile station, a combination of first and second slots is defined as one frame. Further, the transmission period of each of the first and second slots is 30 milliseconds, and the transmission period of one frame, in which the first and second slots are combined, is set to 60 milliseconds. Further, each slot includes a 108-bit payload and a 48-bit SYNC or Embedded Signaling. Note that in the transmission signal of the mobile station, no signal is included in a period of 2.5 milliseconds between adjacent first and second slots, and between adjacent second and first slots.

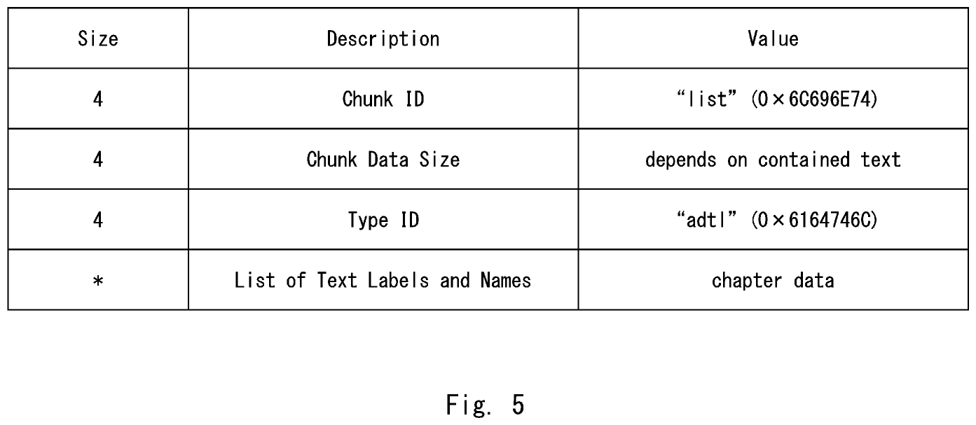

Next, a list chunk format in the communication apparatus 10 will be described with reference to FIG. 5. FIG. 5 shows an example of a list chunk format in the communication apparatus 10 according to the first embodiment.

The list chunk format according to this embodiment includes four items: “Chunk ID”, “Chunk Data Size”, “Type ID”, and “List of Text Labels and Name”. The “Chunk ID” is fixed with a character string “LIST”. The “Chunk Data Size” indicates the size of a data part, and is a size obtained by adding four bytes to the total size of all subordinate chunks. The “List of Text Labels and Name” indicates actual data contents.

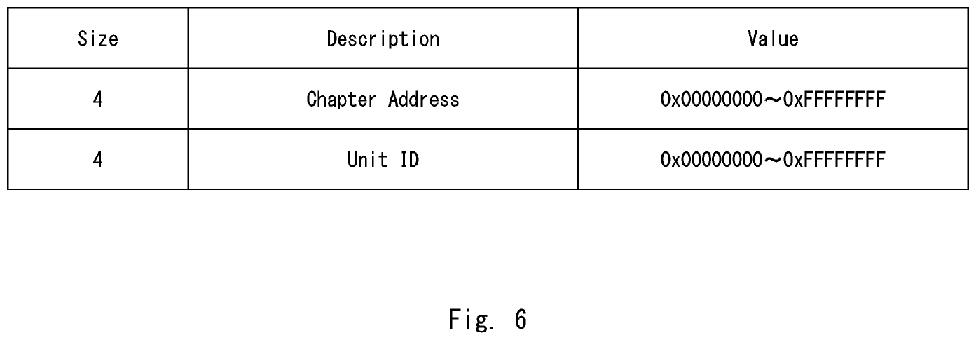

Next, data included in the list chunk will be described with reference to FIG. 6. FIG. 6 is a diagram for explaining data included in the list chunk. The data included in the list chunk includes “Chapter Address” and “Unit ID”. The data sizes of the “Chapter Address” and “Unit ID” are both four bytes. The “Chapter Address” indicates a start position of voice data. The “Unit ID” stores an ID of a radio terminal from which the signal has been received.

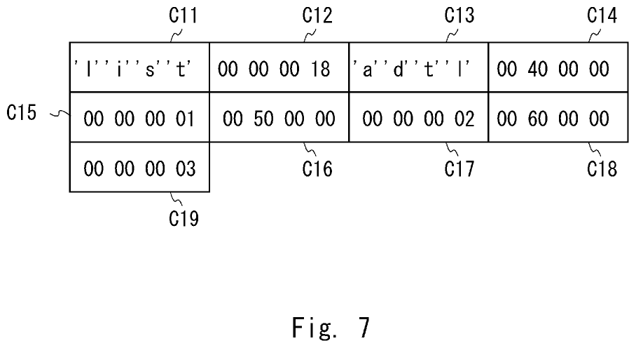

Next, a specific example of the list chunk will be described with reference to FIG. 7. FIG. 7 shows an example of a list chunk in a system according to the first embodiment. The data of the list chunk shown in FIG. 7 is shown in a state where signals are separated at intervals of four bytes.

In the first data C11, “list” is set as a chunk ID. In the second data C12, “00 00 00 18” is set as a chunk data size. That is, in this example shown, the data size is set to 24 bytes (0x18). In the third data C13, “adtl” is set as “Type ID”. In the fourth data C14, “00 40 00 00” is set as an address. In the following data C15, “00 00 00 01” is set as the other station ID.

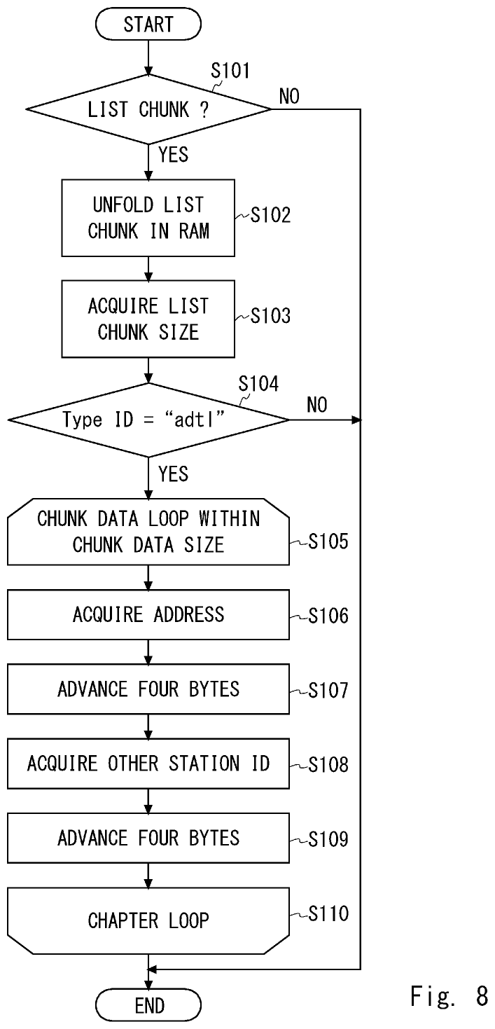

Next, a specific example of the list chunk will be described with reference to FIG. 8. FIG. 8 shows a method for reading a list chunk performed by the communication apparatus 10.

When the communication apparatus 10 receives a signal from any of other communication apparatuses, it reads this signal and determines whether or not the read data is list chunk data (step S101). When it is not determined that the signal is list chunk data (Step S101: No), the communication apparatus 10 finishes this series of processes. When it is determined that the read data is list chunk data (Step S101: Yes), the communication apparatus 10 unfolds the list chunk in a RAM (Step S102).

Next, the communication apparatus 10 acquires the data size of the list chunk unfolded in the RAM (Step S103).

Next, the communication apparatus 10 acquires a Type ID and determines whether or not the Type ID is adtl (Type ID=adtl) (Step S104). When it is not determined that the Type ID is adtl (Type ID=adtl) (Step S104), the communication apparatus 10 finishes this series of processes. When it is determined that the Type ID is adtl (Type ID=adtl) (Step S104), the communication apparatus 10 proceeds to a step S105 and subsequent steps.

In steps S105 to S110, the communication apparatus 10 performs a reading process according to the data size of the chunk data. Specifically, the communication apparatus 10 repeats the following processes within the size of the chunk data. The communication apparatus 10 acquires an address (Step S106). Next, the communication apparatus 10 advances the read address by four bytes (Step S107). Next, the communication apparatus 10 acquires the other station ID (Step S108). Next, the communication apparatus 10 advances the read address by four bytes (Step S109). The communication apparatus 10 repeats the above-described processes until the processing corresponding to the size of the data is completed (Step S110). Then, after the processing corresponding to the size of the data is completed, the communication apparatus 10 finishes the series of processes.

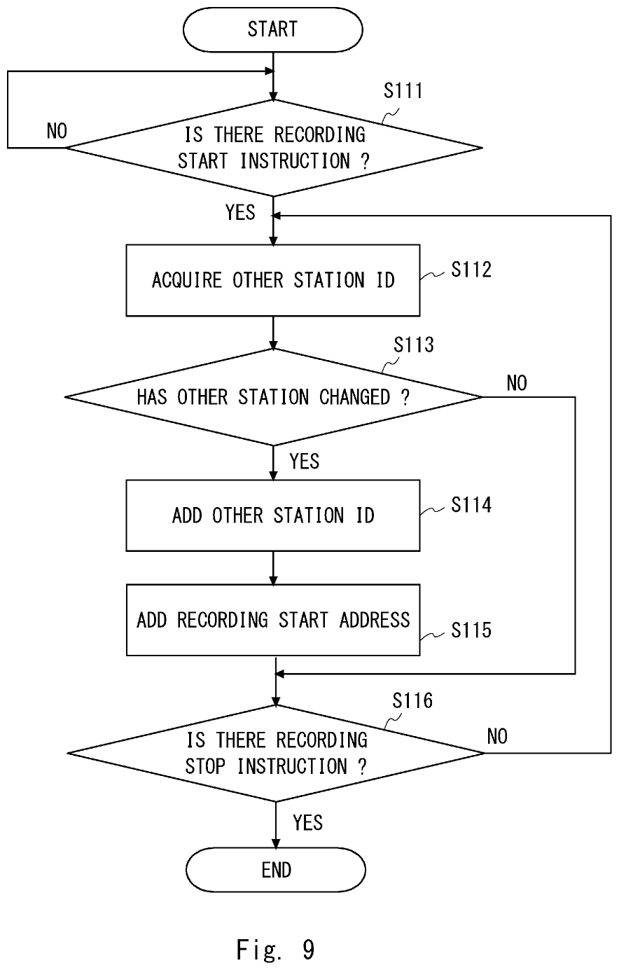

Next, a process for recording the other station ID that is performed when a reception signal received from the other communication apparatus is recorded will be described with reference to FIG. 9. FIG. 9 is a flowchart showing a process for recording a reception signal.

The communication apparatus 10 determines whether or not there is a recording start instruction for a voice signal contained in a reception signal (Step S111). When it is not determined that there is a recording start instruction for a voice signal (Step S111: No), the communication apparatus 10 repeats the step S111. When it is determined that there is a recording start instruction for a voice signal (Step S111), the communication apparatus 10 proceeds to a step S112.

In the step S112, the communication apparatus 10 acquires an ID of the other station contained in the reception signal (Step S112).

Next, the communication apparatus 10 determines whether or not the ID of the other station has been changed from the one in the last recording process (Step S113). When it is not determined that the ID of the other station has been changed (Step S113: No), the communication apparatus 10 proceeds to a step S116. On the other hand, when it is determined that the ID of the other station has been changed (Step S113: No), the communication apparatus 10 proceeds to a step S114.

In the step S114, the communication apparatus 10 adds the changed ID of the other station (Step S114).

Next, when the ID of the other station is added, the communication apparatus 10 adds the recording start address to the ID of the other station in the data to be recorded (Step S115).

In the step S116, the communication apparatus 10 determines whether or not there is a recording stop instruction (Step S116). When it is not determined that there is a recording stop instruction (Step S116: No), the communication apparatus 10 returns to the step S112. When it is determined that there is a recording stop instruction (Step S116: Yes), the communication apparatus 10 finishes this series of processes.

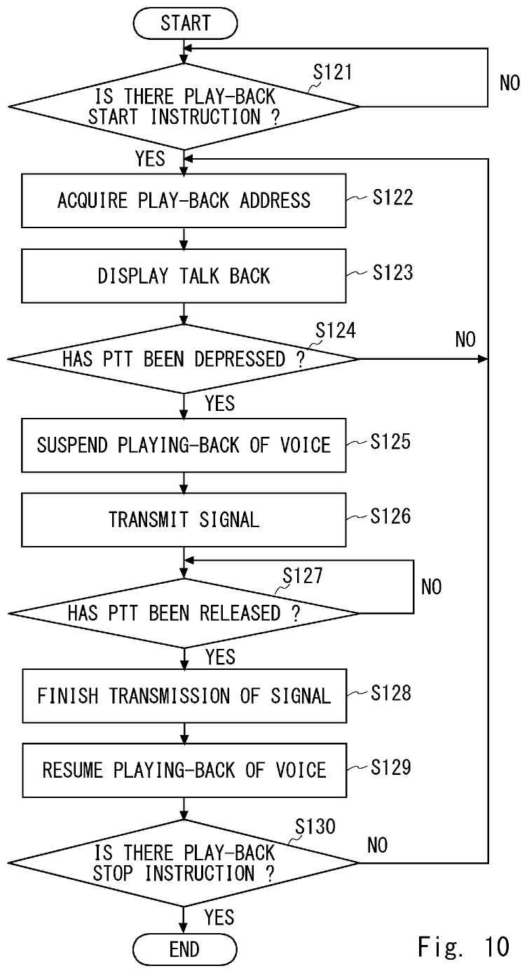

Next, a talk-back process that is performed by the communication apparatus 10 while it is playing back recorded data will be described with reference to FIG. 10. FIG. 10 is a flowchart showing the talk-back process that is performed while recorded data is being played back.

Firstly, the communication apparatus 10 determines whether or not there is an instruction to play back recorded data (Step S121). When it is not determined that there is an instruction to play back recorded data (Step S121: No), the communication apparatus 10 repeats the step S121. When it is determined that there is an instruction to play back the recorded data (Step S121: Yes), the communication apparatus 10 proceeds to a step S122.

In the step S122, the communication apparatus 10 acquires a play-back address for the voice signal which is being played back (Step S122). Next, the communication apparatus 10 displays talk-back on the display unit 11 (Step S123).

Next, the communication apparatus 10 determines whether or not the PTT switch has been depressed (Step S124). When it is not determined that the PTT switch has been depressed (Step S124: No), the communication apparatus 10 returns to the step S122. When it is determined that the PTT switch has been depressed (Step S124: Yes), the communication apparatus 10 proceeds to a step S125.

In the step S125, the communication apparatus 10 suspends the playing-back of the voice (Step S125). Further, as a talk-back process, the communication apparatus 10 transmits a signal related to a voice collected by the microphone 16 of the communication apparatus 10 (Step S126).

Next, the communication apparatus 10 determines whether or not the depressed PTT switch has been released (Step S127). When it is not determined that the PTT switch has been released (Step S127: No), the communication apparatus 10 repeats the step S127. When it is determined that the PTT switch has been released (Step S127: Yes), the communication apparatus 10 finishes the transmission of the transmission signal (Step S128).

Next, the communication apparatus 10 resumes the suspended playing-back of the voice (Step S129). Next, the communication apparatus 10 determines whether or not it has been instructed to stop the playing-back of the voice (Step S130). When it is not determined that it has been instructed to stop the playing-back of the voice (Step S130: No), the communication apparatus 10 returns to the step S122 and repeats the series of processes. When it is determined that it has been instructed to stop the playing-back of the voice (Step S130: Yes), the communication apparatus 10 finishes the series of processes.

The communication apparatus 10 according to the first embodiment has been described above. The communication apparatus 10 according to the first embodiment may receive a signal from another communication apparatus through a repeater as shown in FIG. 3, or may directly receive a signal from another communication apparatus without the repeater being interposed therebetween. By the above-described configuration and functions, the communication apparatus 10 can transmit/receive two signals in conformity with DMR.

Further, for example, when the first reception signal is received in the first slot and then the second reception signal having a priority higher than that of the first reception signal is received in the second slot, the communication apparatus 10 switches the slot for outputting a voice from the first slot for the first reception signal to the second slot for the second reception signal. Further, the communication apparatus 10 makes the recording device to start recording a signal corresponding to at least a voice signal contained in the first reception signal. In this way, the communication apparatus 10 can prevent the user thereof from missing a voice from the other station having a relatively low priority.

Further, when the communication apparatus 10 is playing back recorded voice data while receiving no signal in both the first and second slots, it transmits a transmission signal to the other station related to the voice data, which it is playing back, when the PTT switch is depressed. In this way, the communication apparatus 10 can easily resume the communication with the other station related to the recorded reception signal.

As described above, according to this embodiment, it is possible to provide a communication apparatus and the like capable of preventing a problem or the like which would otherwise be caused by the switching of slots.

### Second Embodiment

Next, a second embodiment will be described. Processes performed by a control unit 18 of a communication apparatus 10 according to the second embodiment differs from those performed in the first embodiment.

The control unit 18 according to this embodiment will be described hereinafter. For ease of understanding, the following description is given by using an example case where a first reception signal is received in a first slot and then a second reception signal having a priority higher than that of the first reception signal is received in a second slot. Note that in this case, the control unit 18 switches the slot for outputting a voice from the first slot for the first reception signal to the second slot for the second reception signal. Further, the control unit 18 may make the recording device start recording a signal corresponding to at least a voice signal contained in the first reception signal.

When the reception of the first reception signal is finished before the reception of the second reception signal is finished, the control unit 18 according to this embodiment configures the first slot so that a transmission signal can be transmitted in the first slot during a predefined first period that starts after the reception of the first reception signal is finished. The timing of the end of the predefined first period may be, at the latest, simultaneous with the end of the reception of the second reception signal.

Further, when the reception of the second reception signal is finished before the reception of the first reception signal is finished, the control unit 18 sets the transmission slot to the second slot in a predefined second period that starts after the reception of the second reception signal is finished. The predefined second period is a standby time for a normal response.

Further, when the reception of the first reception signal is continued after the second period is finished, the control unit 18 continues the recording of the first reception signal, and upon the completion of the reception of the second reception signal, starts outputting the voice of the stored first reception signal, i.e., starts the playing-back of the received voice. Further, the control unit 18 configures the transmitting unit 23 so that it can transmit a transmission signal by the first slot during the predefined second period that starts after the reception of the first reception signal is finished.

When the reception of the first reception signal is continued after the second period is finished, and then the reception of the first reception signal is finished, the control unit 18 sets the first slot as the slot for the transmission signal in a period that starts after the output of the voice of the voice signal in the first slot is finished and ends when a predefined third period is finished. The timing of the end of the predefined third period may be, at the latest, simultaneous with the end of the output of the recorded voice signal, i.e., simultaneous with the end of the playing-back of the voice signal. That is, after the end of the first reception signal, the control unit 18 sets the first slot as the slot used for the transmission while the voice is being played back.

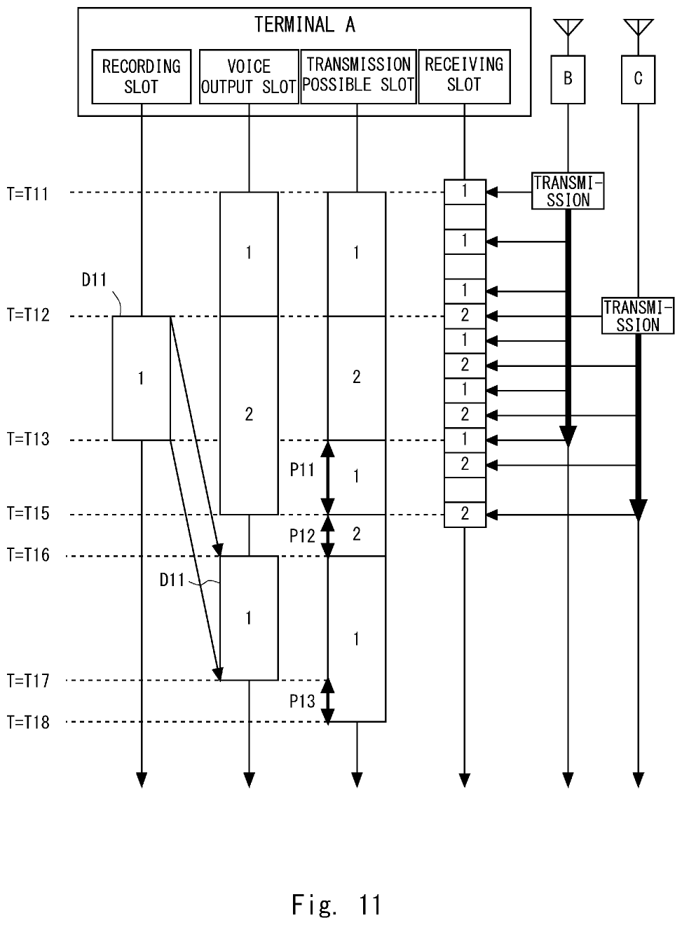

FIG. 11 is a first diagram for explaining functions of a communication apparatus according to the second embodiment. FIG. 11 shows a situation in which signals are transmitted/received between a terminal A and a terminal B or the terminal A and a terminal C, and a state of the terminal A in this situation in a chronological manner from the top to the bottom. More specifically, regarding the state of the terminal A, from left to right, a slot for recording, a slot in which a voice is being output (hereinafter also referred to as a voice output slot), a slot in which transmission can be performed (hereinafter also referred to as a transmission possible slot), and a receiving slot are shown by rectangles inside of each of which “1” or “2” is shown.

At a time T=T11, the terminal B starts transmitting a signal of the first slot to the terminal A. When the terminal A receives the signal of the terminal B (first reception signal), it outputs the voice of the first slot and sets the transmission possible slot to the first slot. Note that since the communication apparatus 10 performs half-duplex communication, the transmission of a signal from the terminal A to the terminal B becomes possible after the transmission of a signal from the terminal B is finished.

Next, at a time T12 after the time T11, the terminal C starts transmitting a signal of the second slot to the terminal A. Note that the priority of the signal transmitted from the terminal C is set higher than that of the signal transmitted from the terminal B. When the terminal A receives the signal of the second slot (second reception signal), it reads its priority and switches the settings of the voice output slot and the transmission possible slot to the second slot. As a result, the signal for the voice output from the speaker is switched from the first reception signal to the second reception signal. Further, the terminal A starts recording the first reception signal related to the first slot in the recording device.

Next, at a time T13 after the time T12, the terminal B finishes the transmission of the signal to the terminal A. As a result, the terminal A finishes the recording of the first reception signal in the recording device. Note that data from the time T12 to the time T13 shown in FIG. 11 is referred to as recorded data D11.

Next, in a first period P11 from the time T13 to a time T15, the transmission possible slot is set to the first slot. That is, even when the voice output from the speaker is the one in the second slot, the communication apparatus 10 according to this embodiment configures the first slot so that it can transmit a signal during a predetermined period that starts immediately after the reception in the first slot is finished. In other words, the communication apparatus 10 according to this embodiment temporarily permits the transmission to the terminal B even when the voice of the reception signal related to the terminal C is being output in the first period P11 which is a period after the transmission by the terminal B is finished and before the transmission by the terminal C is finished. In this way, the communication apparatus 10 can notify the user of the terminal B of the situation of the terminal A. The situation of the terminal A is, for example, a situation in which its user has not heard the voice transmitted from the terminal B halfway through the call, or a situation in which the terminal A is outputting the reception signal of the terminal C having a priority higher than that of the terminal B. Note that when the communication apparatus 10 is continuously receiving the second reception signal from the terminal C after the predetermined period has elapsed, it returns the transmission possible slot to the second slot.

Next, at a time T15, the terminal C finishes the transmission of the signal to the terminal A. As a result, the setting of the second slot for outputting the voice is finished. Further, in a period P12 from the time T15 to a time T16, the communication apparatus 10 maintains the setting in which the transmission possible slot is set to the second slot. That is, this period P12 is a period that is immediately after the second reception signal transmitted from the terminal C is stopped and is set so that a response to the terminal C is possible.

Next, at an arbitrary time T16 after the period P12 is finished, the communication apparatus 10 may play back the recorded data D11 recorded by the recording device. In the communication apparatus 10, when the playing-back is started, the destination of the transmission and the transmission possible slot are set based on the recorded contents as being set in the first embodiment. For example, the communication apparatus 10 sets the transmission possible slot to the first slot.

Next, at a time T17 after the time T16, the playing-back of the recorded data D11 is finished. The communication apparatus 10 may set the transmission possible slot to the first slot in a period from the time T17 until a time T18 when a predetermined period P13 has elapsed from the time T17. In this way, the communication apparatus 10 can respond to the terminal B related to the voice of which the playing-back has been finished.

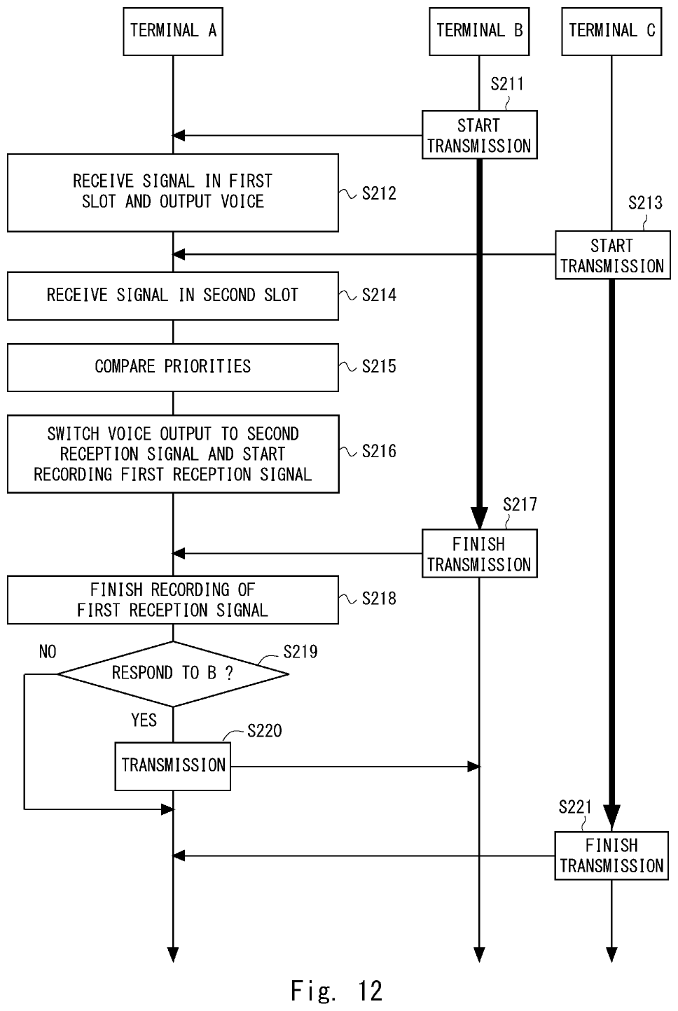

Next, processes performed by the communication apparatus according to this embodiment will be further described with reference to FIG. 12. FIG. 12 is a first sequence diagram showing processes performed by the communication apparatus according to the second embodiment. The sequence diagram shown in FIG. 12 corresponds to the operations performed by the terminals A, B, and C, respectively, shown in FIG. 11.

Firstly, the terminal B starts transmitting a signal to the terminal A (Step S211). Next, the terminal A receives the signal transmitted from the terminal B as a first reception signal in the first slot, and outputs a voice related to the first reception signal from the speaker (Step S212).

Next, the terminal C starts transmitting a signal having a relatively high priority to the terminal A (Step S213). The terminal A receives the signal transmitted from the terminal C as a second reception signal in the second slot (Step S214). The communication apparatus 10 compares the priority of the first reception signal with that of the second reception signal (Step S215), and switches the signal the voice of which is output from the first reception signal to the second reception signal. Further, the communication apparatus 10 starts recording the first reception signal (Step S216). Therefore, the terminal A continues the recording of the first reception signal, which is the signal transmitted from the terminal B, while continuing the output of the voice of the second reception signal, which is the signal transmitted from the terminal C.

Next, the terminal B finishes the transmission of the signal to the terminal A (Step S217). As a result, the terminal A finishes the recording of the first reception signal (Step S218). At this point, although the terminal A is continuing to output the voice of the second reception signal, the user of the terminal A can recognize, by notification means such as a display, that the signal of the first slot, which corresponds to the above-described back slot, (i.e., the first reception signal) has ended.

Next, the terminal A is configured so that the user of the terminal A transmits a signal to the terminal B in the first period P11 shown in FIG. 11. Specifically, the terminal A sets the transmission possible slot to the first slot during a period from the end of the transmission by the terminal B, for which the first slot has been used, to the end of the transmission by the terminal C, for which the second slot has been used.

The terminal A determines whether or not the user of the terminal A has performed an operation for responding to the terminal B (Step S219). That is, the terminal A determines whether or not the user of the terminal A has performed an operation for transmitting a signal to the terminal B in the first period P11 shown in FIG. 11. When the user of the terminal A responds to the terminal B (Step S219: Yes), the terminal A transmits, to the terminal B, a predetermined message for the terminal B or an arbitrary voice spoken by the user of the terminal A (Step S220). On the other hand, when the user of the terminal A does not respond to the terminal B (Step S219: No), the terminal A skips the step S220. Next, the terminal C finishes the transmission of the signal to the terminal A (Step S221). Although the above-described operations have been described as being manually performed by a human being, the system or the like may be configured so that, when the conditions for performing the above-described processes are satisfied, a fixed message, for example, a message “Your signal has been interrupted due to the reception of a signal having a higher priority”, is automatically sent.

Through the above-described processes, it is possible to prevent a problem or the like in the transmission of information from the user of the terminal B which would otherwise be caused by the switching of slots upon the start of transmission from the terminal C.

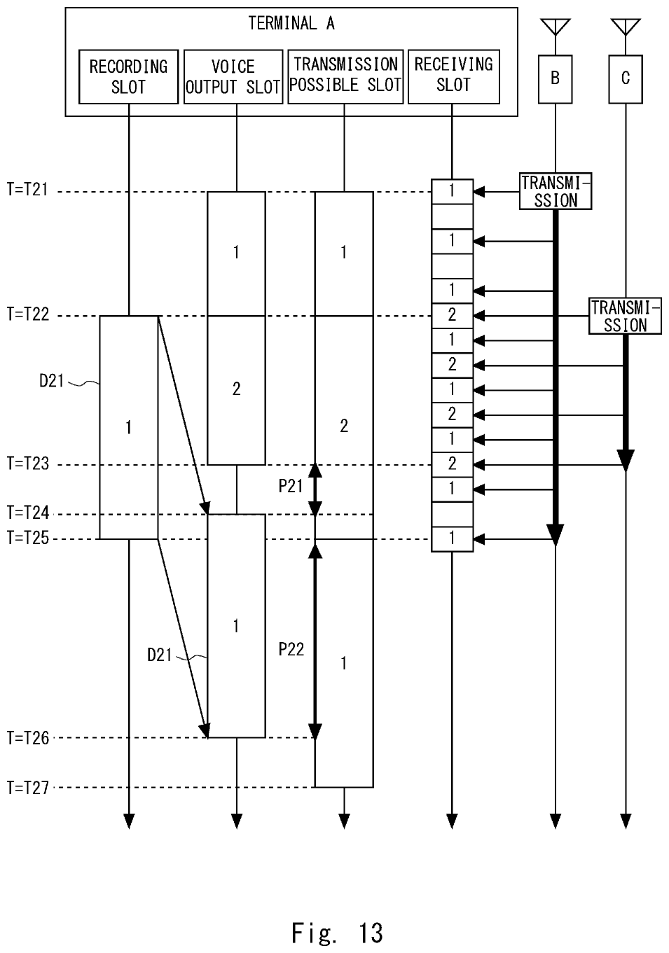

Next, a case where the transmission from the terminal B shown in FIG. 13 ends first, i.e., a case where the first reception signal ends first, will be described. FIG. 13 is a second diagram for explaining functions of the communication apparatus according to the second embodiment. The example shown in FIG. 13 differs from that shown in FIG. 11 in that the transmission from the terminal B to the terminal A ends after the transmission from the terminal C to the terminal A ends.

At a time T=T21, the terminal B starts transmitting a signal of the first slot to the terminal A. When the terminal A receives the first reception signal of the terminal B, it outputs the voice of the first slot and sets the transmission possible slot to the first slot.

Next, at a time T22 after the time T21, the terminal C starts transmitting a signal of the second slot to the terminal A. Note that similarly to the case shown in FIG. 11, when the terminal A receives the second reception signal of the second slot, it reads its priority and switches the settings of the voice output slot and the transmission possible slot to the second slot. As a result, the signal for the voice output from the speaker is switched from the first reception signal to the second reception signal. Further, the terminal A starts recording the first reception signal related to the first slot in the recording device. Note that data from the time T22 to the time T25 shown in FIG. 13 is referred to as recorded data D21.

Next, at a time T23 after the time T22, the terminal C finishes the transmission of the signal to the terminal A. As a result, the terminal A finishes the outputting of the voice of the signal received in the second slot. Further, in a period P21 from the time T23 to a time T24, the communication apparatus 10 maintains the second slot as the transmission possible slot. That is, the period P21 is a period that is immediately after the second reception signal transmitted from the terminal C is stopped and is set so that a response to the terminal C is possible.

Next, the terminal A starts playing back the recorded data D21 recorded by the recording device at the time T24 when the period P21 ends. If the transmission from the terminal B continues after the time T24, the terminal A continues the recording in the recording device.

Next, when the terminal B finishes the transmission of the signal to the terminal A at a time T25 after the time T24, the terminal A finishes the recording of the first reception signal (recorded data D21) in the recording device. At this point, although the terminal A is continuing to play back the recorded data D21 (to output the voice), the user of the terminal A can recognize, by notification means such as a display, that the signal of the first slot (first reception signal) has ended based on the fact that, for example, the recording has been stopped or the first reception signal has not been detected any longer.

Next, the terminal A is configured so that the user of the terminal A can transmit a signal to the terminal B in the second period P22 shown in FIG. 13. Specifically, the terminal A is configured so that transmission can be performed in the first slot during a period from a time point when the transmission from the terminal B, for which the first slot has been used, is finished (i.e., from a time T25) to the end of the playing-back of the recorded data D21 (i.e., to a time T26). Further, if the transmission from the terminal B is finished during the period P21, the terminal A starts the playing-back of the recorded data D21 and sets the first slot as the transmission possible slot because the transmission from the terminal B, for which the first slot has been used, has already been finished after the end of the period P21. That is, the communication apparatus 10 according to the second embodiment sets the first slot as the transmission possible slot when the playing-back of the recorded data D21 is already started and the first reception signal has ended in the terminal A.

Next, the playing-back of the recorded data D21 is finished at a time T26 after the time T25. The communication apparatus 10 may maintain the setting of the first slot as the transmission possible slot from the time T26 to a time T27 when a predetermined third period P22 has elapsed from the time T26. As a result, the communication apparatus 10 may be able to respond to the terminal B related to the voice the playing-back of which has been finished.

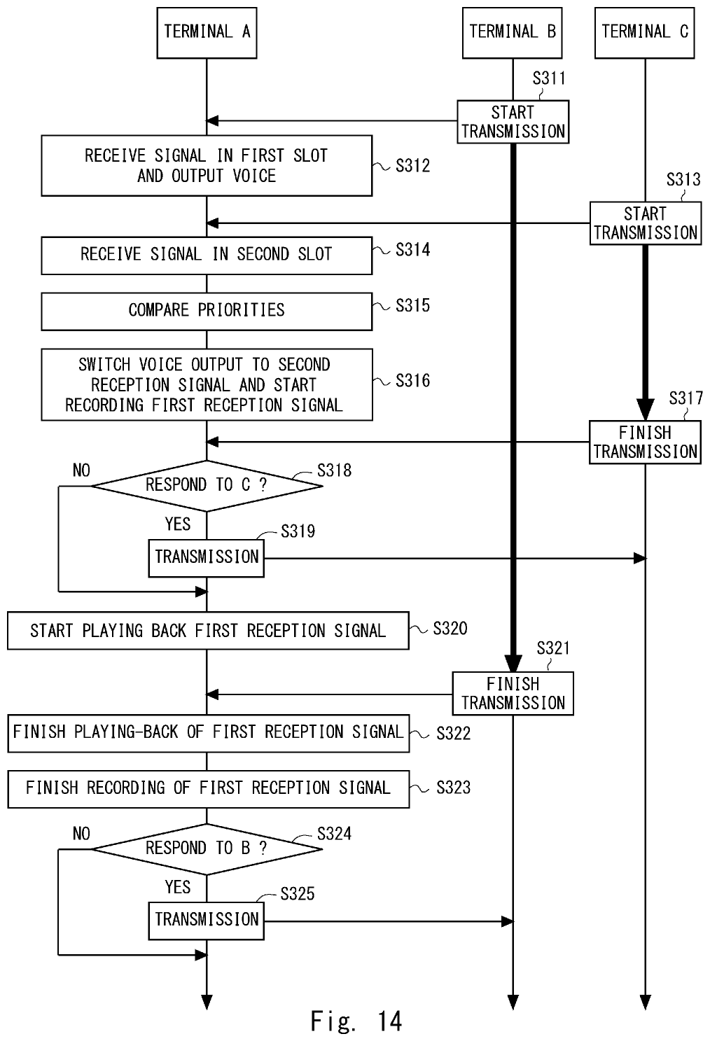

Next, processes that are performed in the situation shown in FIG. 13 will be further described with reference to FIG. 14. FIG. 14 is a second sequence diagram showing processes performed by the communication apparatus according to the second embodiment.

Firstly, the terminal B starts transmitting a signal to the terminal A (Step S311). Next, the terminal A receives the signal transmitted from the terminal B as a first reception signal in the first slot, and outputs a voice related to the first reception signal from the speaker (Step S312).

Next, the terminal C starts transmitting a signal having a relatively high priority to the terminal A (Step S313). The terminal A receives the signal transmitted from the terminal C as a second reception signal in the second slot (Step S314). The communication apparatus 10 compares the priority of the first reception signal with that of the second reception signal (Step S315), switches the signal the voice of which is output from the first reception signal to the second reception signal, and starts recording the first reception signal (Step S316).

Next, the terminal C finishes the transmission of the signal to the terminal A (Step S317). As a result, the terminal A determines whether or not to respond to the terminal C (Step S318). That is, the terminal A determines whether or not the user of the terminal A transmits a signal to the terminal C in the period P21 shown in FIG. 13. When it is determined to respond to the terminal C (Step S318: Yes), the terminal A transmits, to the terminal C, a predetermined message for the terminal C or an arbitrary voice spoken by the user of the terminal A (Step S319). On the other hand, when it is not determined to respond to the terminal C (Step S318: No), the terminal A skips the step S319.

Next, the terminal A starts playing back the recorded first reception signal (recorded data D21) after the period P21 has ended (Step S320).

Next, the terminal A continues the recording of the first reception signal while continuing the playing-back of the recorded first reception signal. The terminal B finishes the transmission of the signal to the terminal A (Step S321). As a result, the terminal A finishes the recording of the first reception signal (Step S322). Further, the terminal A finishes the playing-back of the first reception signal (Step S323).

The terminal A determines whether or not the user of the terminal A has performed an operation for responding to the terminal B (Step 324). That is, the terminal A determines whether or not the user of the terminal A has performed an operation for transmitting a signal to the terminal B in a second period P22 shown in FIG. 13. When the user of the terminal A responds to the terminal B (Step S324: Yes), the terminal A transmits, to the terminal B, a predetermined message for the terminal B or an arbitrary voice spoken by the user of the terminal A (Step S325). On the other hand, when the user of the terminal A does not respond to the terminal B (Step S324: No), the terminal A skips the step S325. Although the above-described operations have been described as being manually performed by a human being, the system or the like may be configured so that, when the conditions for performing the above-described processes are satisfied, a fixed message, for example, a message “Your signal has been interrupted due to the reception of a signal having a higher priority”, is automatically sent.

Note that when the communication apparatus 10 responds during the playing-back of the first reception signal, it may suspend the playing-back process of the recorded data D21 when the PTT switch is depressed, and then resume the playing-back after the PTT switch is released.

The second embodiment has been described above. As described above, the communication apparatus 10 according to the second embodiment makes it possible to temporarily respond to the terminal B related to the first slot when the transmission of the first slot having a relatively low priority ends before the transmission of the second slot having a relatively high priority.

Note that in this case, the communication apparatus 10 cannot transmit a voice spoken by the user to the terminal B while listening to a voice transmitted from the terminal C. Therefore, under such circumstances, the communication apparatus 10 may transmit, for example, a predetermined text message to the terminal B.

As described above, according to the second embodiment, it is possible to provide a communication apparatus and the like capable of preventing a problem or the like which would otherwise be caused by the switching of slots.

### Third Embodiment

Next, a third embodiment will be described. A communication apparatus 10 according to the third embodiment differs from those according to the above-described embodiments in that the communication apparatus 10 according to the third embodiment can transmit a predetermined interrupt request signal to the other station that is transmitting a signal to its own station.

The interrupt request signal according to this embodiment is a signal that is, when “call interruption” is performed according to DMR standards, transmitted from the receiving communication apparatus to the transmitting communication apparatus at a predetermined timing. The call interruption is a technique in which the other station transmitting a signal switches a predetermined period (e.g., a period corresponding to one slot) to a period for reception at a predetermined timing, and when the other station transmitting a signal to the own station switches the predetermined period to the period for reception as described above, the own station (the communication apparatus) transmits an interrupt request signal, and the other station, which has received the interrupt request signal, suspends the transmission. Information about the above-described predetermined timing is transmitted from the other station to the own station at a timing earlier than the predetermined timing. The communication apparatus 10 according to this embodiment is configured so as to be able to transmit an interrupt request signal to the other communication apparatus, and the other communication apparatus is configured so as to be able to receive the interrupt request signal.

The control unit 18 according to this embodiment switches, when a first reception signal is received in the first slot and then a second reception signal having a priority higher than that of the first reception signal is received in the second slot, the slot for outputting a voice from the first slot for the first reception signal to the second slot for the second reception signal, and transmits an interrupt request signal to the entity or the like that has transmitted the first reception signal as a transmission signal.

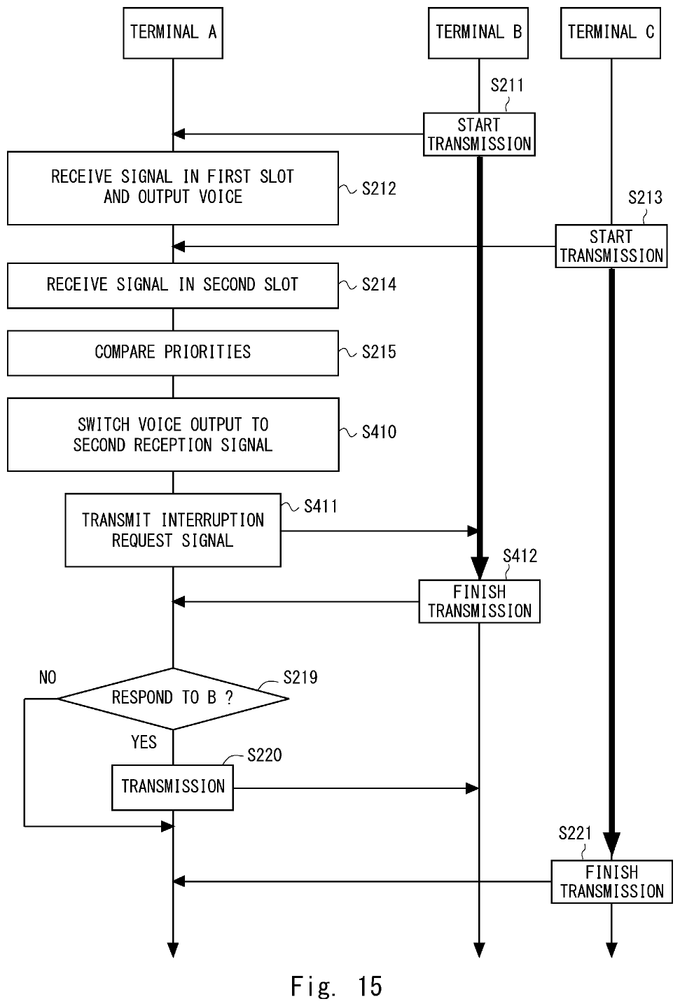

FIG. 15 is a first sequence diagram showing processes performed by a communication apparatus according to the third embodiment. In the sequence diagram shown in FIG. 15, processes in steps S215 to S219 are different from those in the sequence diagram shown in FIG. 12. Further, the sequence diagram shown in FIG. 15 is similar to the sequence diagram shown in FIG. 12, except for the above-described difference.

In a terminal A according to this embodiment, the communication apparatus 10 compares the priority of the first reception signal with that of the second reception signal (Step S215), and switches the slot for outputting a voice from the first slot for the first reception signal to the second slot for the second reception signal (Step S410). Note that the terminal A starts outputting a voice signal related to the second reception signal, and continues the detection of the first reception signal. Further, the terminal A operates notification means for indicating that the first reception signal is continuously being received. That is, for example, the terminal A displays an image, text, or the like indicating the aforementioned “Back Slot Busy”, or turns on an LED(s) or the like indicating that the first reception signal is being received. Note that the terminal A may start recording the first signal as in the first and second embodiments.

Next, the terminal A transmits an interrupt request signal to the terminal B (Step S411). Note that the terminal A may be configured so as to automatically transmit the interrupt request signal. Further, the terminal A may be configured so as to transmit the interrupt request signal in response to an operation performed by a user.

The terminal B receives the interrupt request signal while transmitting the transmission signal to the terminal A. The terminal B recognizes the interrupt request signal transmitted from the terminal A, so that it finishes the transmission of the transmission signal to the terminal A (Step S412). In this case, for example, the terminal B may display a message indicating that the interrupt request signal has been received on a display unit of the terminal B. The user of the terminal B visually recognizes the message displayed on the display unit of the terminal B, and hence can recognize that the transmission to the terminal A has been stopped, i.e., the transmission has been stopped due to call interruption. The user of the terminal B stops the transmitting operation because the call interruption has been received.

Meanwhile, the terminal A receives the transmission signal from the terminal C, i.e., the second reception signal, and waits until the transmission signal from the terminal B, i.e., the first reception signal, ends while outputting a voice. Since the terminal A is continuing the detection of the first reception signal, it can recognize that the terminal B has stopped the transmission based on the fact that the detection of the first reception signal is stopped (i.e., it no longer detects the first reception signal). For example, the terminal A may stop the display of the aforementioned “Back Slot Busy” or the notification by the notification means such as an LED(s), or notify the user that the terminal B has stopped the transmission by displaying “Back Slot Open” or the like, which means that the back slot is empty, or turning on an LED(s) or the like having a color different from that of the aforementioned LED(s).

Next, the terminal A determines whether or not to respond to the terminal B (Step S219). That is, similarly to the second embodiment, the terminal A determines whether or not the user of the terminal A transmits a signal to the terminal B in the first period P11 shown in FIG. 11. When it is determined to respond to the terminal B (Step S219: Yes), the terminal A transmits, to the terminal B, a predetermined message for the terminal B or an arbitrary voice spoken by the user of the terminal A (Step S220). On the other hand, when it is not determined to respond to the terminal B (Step S219: No), the terminal A skips the step S220. The third embodiment differs from the second embodiment in that the terminal A according to the third embodiment stops the transmission by the terminal B by performing call interruption. In the second embodiment, the processes to be performed change according to which of the first and second reception signals ends before the other reception signal. In contrast, in the third embodiment, it is possible, by call interruption, to finish the first reception signal before the second reception signal immediately after the start of the reception of the second reception signal.

In the third embodiment, the terminal A can stop the transmission by the terminal B. Therefore, after that, the terminal A may start transmission to the terminal B without requiring the determination made by the user of the terminal A. However, depending on the contents of the second reception signal, the user needs to attentively listen to the contents thereof. Therefore, the terminal A may leave the determination as to whether or not the terminal A should perform the transmission to the determination made by the user of the terminal A. In any case, the slot set for transmission during the period of the reception of the second reception signal is not the slot for the second reception signal, in which the second reception signal is currently being received and the voice thereof is currently being output, but is the slot for the first reception signal, i.e., the slot that has been used for the communication with the terminal B.

The third embodiment has been described above. Note that the third embodiment does not necessarily have to include the recording device 14. However, the terminal A, i.e., the communication apparatus 10 according to this embodiment, may include the recording device 14 in the case where the determination as to whether or not to transmit an interrupt request signal is left to (i.e., made by) an operation performed by the user of the terminal A, or/and may be configured so that the first reception signal is recorded in the recording device 14. That is, the user of the terminal A can select whether to forcibly stop the transmission by the terminal B by issuing an interrupt request, or to wait until the transmission from the terminal B is finished while recording the transmission.

As described above, according to the third embodiment, it is possible to provide a communication apparatus and the like capable of preventing a problem or the like which would otherwise be caused by the switching of slots.

### Fourth Embodiment

Next, a fourth embodiment will be described. The fourth embodiment includes the recording device 14, determines the priority level of the second reception signal, and determines whether to issue an interrupt request or to perform recording. That is, the fourth embodiment differs from the third embodiment, in which the determination as to whether or not to transmits an interrupt request signal is left to an operation performed by the user, in the above-described feature.

The present disclosure has been consistently described on the assumption that when the priority of the second reception signal is higher than that of the first reception signal, the communication apparatus 10 switches the signal for outputting a voice to the second reception signal. In the case of the second embodiment, since the contents transmitted by the first reception signal are recorded, the user of the terminal A can recognize the whole contents transmitted from the terminal B. However, in the case of the third embodiment, the terminal A stops the first reception signal halfway through the transmission. Therefore, the whole contents that the user of the terminal B attempts to transmit may not be conveyed to the user of the terminal A. Further, in the third embodiment, whether the first reception signal is recorded or not may be determined by whether or not the user of the terminal A performs an interrupt request operation. This embodiment is characterized in that whether the first reception signal is recorded or not is determined based on a difference between the priorities of the first and second reception signals or based on their absolute priorities.

In the fourth embodiment, the control unit 18 determines whether to record the first reception signal or to transmit an interrupt request signal (i.e., perform call interruption) to the entity or the like that has transmitted the first reception signal based on the relationship between the priorities of the first and second reception signals. Specifically, the control unit 18 determines whether to record the first reception signal or to transmit an interrupt request signal (i.e., perform call interruption) to the entity or the like that has transmitted the first reception signal based on a difference between the priorities of the first and second reception signals or based on their absolute priorities, and performs control based on the result of the determination. The control unit 18 may convert a priority output from the baseband signal processing unit 19 into a numerical value based on information about the priority. Regarding the conversion of a priority into a numerical value, for example, the priority of an emergency call is defined as 3; the priority of communication within a group is defined as 3; and the priority of individual communication is defined as 1. Further, regarding the criterion for determination, when the difference is 1, the signal is recorded, and when the difference is 2, call interruption is performed. Further, when the second reception signal is an emergency call, call interruption may be performed, and in all the other cases, the signal may be recorded.

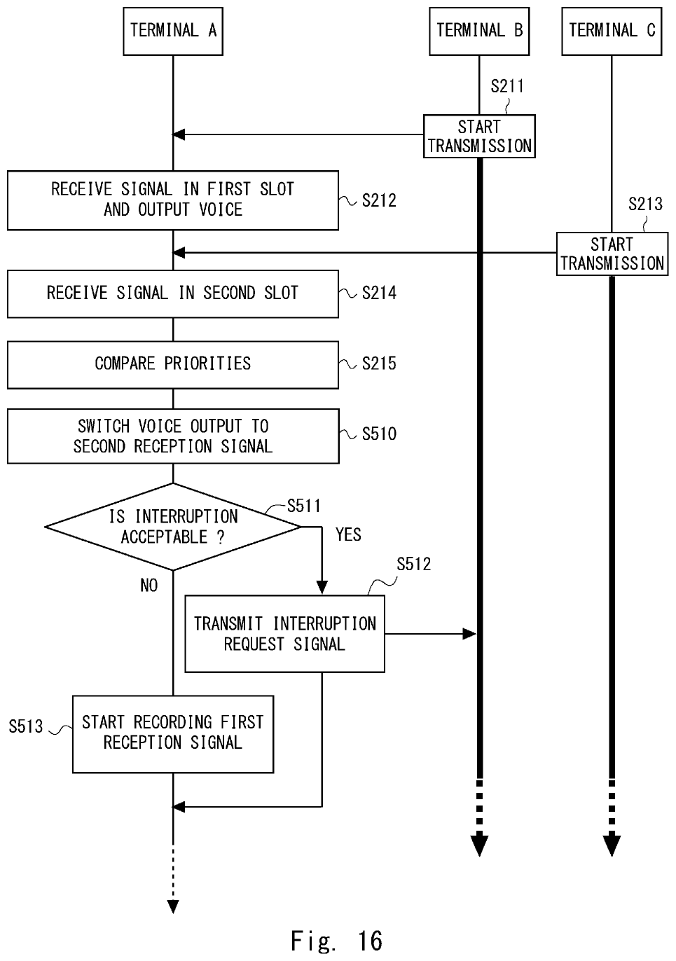

FIG. 16 is a sequence diagram showing processes performed by a communication apparatus according to the fourth embodiment. The sequence diagram shown in FIG. 16 shows an example in which a priority contained in the first reception signal is lower than that contained in the second reception signal, i.e., a priority contained in the second reception signal is higher than that contained in the first reception signal. Note that, needless to say, when the priority contained in the first reception signal is higher than that contained in the second reception signal, the terminal A continues the outputting of the voice related to the first reception signal received from the terminal B.

A terminal A according to this embodiment compares a priority contained in a first reception signal received from a terminal B with that contained in a second reception signal received from a terminal C (Step S215).

As described above, when the priority contained in the second reception signal is lower than that contained in the first reception signal, the terminal A continues the reception of the first reception signal. When the priority contained in the second reception signal is higher than that contained in the first reception signal, the terminal A switches the signal for outputting a voice to the second reception signal (Step S510).

Next, when the priority contained in the second reception signal is higher than that contained in the first reception signal, the terminal A further determines whether or not the priorities of the first and second reception signals satisfy a predetermined relationship therebetween. More specifically, the terminal A determines whether or not the terminal B accepts an interrupt request based on the relationship between the priorities of the first and second reception signals (Step S511). When it is determined that the terminal B accepts an interrupt request (Step S511: Yes), the terminal A transmits an interrupt request signal to the terminal B (Step S512). Further, in this case, the terminal A skips a step S513 (which will be described later).

On the other hand, when it is not determined that the terminal B accepts an interrupt request (Step S511: No), the terminal A starts recording the first reception signal (Step S513).

In the case of Yes in the step S511, the terminal A performs, as processes performed after those shown in FIG. 16, the same processes as those performed after the step S411 shown in the third embodiment. That is, the terminal A stops the transmission by the terminal B by an interrupt request signal, and switches the transmission slot to the slot that has been used for the communication with the terminal B until the transmission from the terminal C stops.

On the other hand, in the case of No in the step S511, the terminal A performs, as the processes performed after those shown in FIG. 16, the same processes as those performed after the step S216 or S316 shown in the second embodiment. That is, the terminal A outputs the voice of the second reception signal while continuously recording the first reception signal transmitted from the terminal B. The fact that the processes change according to which of the transmission from the terminal B and the transmission from the terminal C ends before the other transmission is the same as that in the second embodiment.

The fourth embodiment has been described above. Note that the setting of a priority according to this embodiment may be based on the absolute value of the numerical value converted from the priority. Alternatively, for example, a relative corresponding relationship between the priorities of signals related to the first and second slots may be individually set. As described above, when the priority of the second reception signal (the signal of the second slot) is lower than that of the first reception signal (the signal of the first slot), the outputting of the voice of the first reception signal is continued, and the signal the voice of which is output is not switched to the second reception signal.

That is, assume that, for example, the system or the like may be configured so that when the priority contained in the first reception signal is “2” and the priority contained in the second reception signal is “3”, which is higher than “2”, an interrupt request signal is transmitted for the first slot. In this case, the system or the like may be configured so that when the priority contained in the first reception signal is “1” and the priority contained in the second reception signal is “3”, no interrupt request signal is transmitted for the first slot.

By individually setting a corresponding relationship according to the priority as described above, the communication apparatus 10 according to this embodiment can make settings as to how to handle reception signals or the like by switching slots in a flexible manner. As described above, according to the fourth embodiment, it is possible to provide a communication apparatus and the like capable of preventing a problem or the like which would otherwise be caused by the switching of slots.

The above-described program includes a set of instructions (or software codes) that, when being loaded into a computer, causes the computer to perform one or more of the functions described in the embodiments. The program may be stored in a non-transitory computer readable medium or in a physical storage medium. By way of example rather than limitation, a computer readable medium or a physical storage medium may include a random-access memory (RAM), a read-only memory (ROM), a flash memory, a solid-state drive (SSD), or other memory technology, a CD-ROM, a digital versatile disk (DVD), a Blu-ray (registered trademark) disc or other optical disc storages, a magnetic cassette, magnetic tape, and a magnetic disc storage or other magnetic storage devices. The program may be transmitted on a transitory computer readable medium or a communication medium. By way of example rather than limitation, the transitory computer readable medium or the communication medium may include electrical, optical, acoustic, or other forms of propagating signals.

Note that the present invention is not limited to the above-described embodiments, and various modifications can be made thereto within the scope and spirit of the invention.

What is claimed is:

1. A communication apparatus comprising:
a receiving circuit configured to receive a signal in a first slot or a second slot according to a time division multiplexing access scheme;
a transmitting circuit configured to transmit a transmission signal corresponding to the first or second slot according to the time division multiplexing access scheme and by half-duplex communication;
a voice signal decoding circuit configured to handle one of a first reception signal received in the first slot and a second reception signal received in the second slot as a signal for outputting a voice, and decode the voice signal;
a recording device configured so as to be able to record a voice signal contained in at least one of the first and second reception signals;
a baseband signal processing circuit configured to determine a priority in regard to a slot for outputting a voice based on information contained in the first and second reception signals, and output information about the determined priority; and
a control circuit configured to, when the first reception signal is received in the first slot and then the second reception signal having a priority higher than that of the first reception signal is received in the second slot, switch a slot for outputting a voice from the first slot for the first reception signal to the second slot for the second reception signal based on information about the priority, and make the recording device start recording a signal corresponding to at least a voice signal contained in the first reception signal, wherein
the control circuit, when the reception of the first reception signal is finished before the reception of the second reception signal is finished, configures the transmission circuit so that a transmission signal can be transmitted by the first slot during a predefined first period that starts after the reception of the first reception signal is finished.

2. The communication apparatus according to claim 1, wherein a timing of the end of the first period is, at the latest, simultaneous with the end of the reception of the second reception signal.

3. The communication apparatus according to claim 1, wherein
when the reception of the first reception signal is continued after the reception of the second reception signal is finished, the control circuit continues the recording of the first reception signal, and upon completion of the reception of the second reception signal, starts outputting a voice of the stored first reception signal, and
the control circuit configures the transmission circuit so that a transmission signal can be transmitted by the first slot during a predefined second period that starts after the reception of the first reception signal is finished.

4. The communication apparatus according to claim 3, wherein
a timing when the second period starts is after the outputting of the voice of the stored first reception signal is started and after when the reception of the first reception signal is finished, and
a timing of the end of the second period is, at the latest, simultaneous with the end of the outputting of the voice of the stored first reception signal.

5. A communication apparatus comprising:
a receiving circuit configured to receive a signal in a first slot or a second slot according to a time division multiplexing access scheme;
a transmitting circuit configured to transmit a transmission signal corresponding to the first or second slot according to the time division multiplexing access scheme and by half-duplex communication;
a voice signal decoding circuit configured to handle one of a first reception signal received in the first slot and a second reception signal received in the second slot as a signal for outputting a voice, and decode the voice signal;
a recording device configured so as to be able to record a voice signal contained in at least one of the first and second reception signals;
a baseband signal processing circuit configured to determine a priority in regard to a slot for outputting a voice based on information contained in the first and second reception signals, and output information about the determined priority; and
a control circuit configured to, when the first reception signal is received in the first slot and then the second reception signal having a priority higher than that of the first reception signal is received in the second slot, switch a slot for outputting a voice from the first slot for the first reception signal to the second slot for the second reception signal based on information about the priority, and make the recording device start recording a signal corresponding to at least a voice signal contained in the first reception signal, wherein
when the reception of the first reception signal is continued after the reception of the second reception signal is finished, the control circuit continues the recording of the first reception signal, and upon completion of the reception of the second reception signal, starts outputting a voice of the stored first reception signal,
the control circuit configures the transmission circuit so that a transmission signal can be transmitted by the first slot during a predefined second period that starts after the reception of the first reception signal is finished,
a timing when the second period starts is after the outputting of the voice of the stored first reception signal is started and after when the reception of the first reception signal is finished, and
a timing of the end of the second period is, at the latest, simultaneous with the end of the outputting of the voice of the stored first reception signal.
